(19) United States
(12) Patent Application Publication
(10) Pub. No.: US 2005/0028938 A1
(43) Pub. Date: Feb. 10, 2005

(54) Systems and methods of bonding materials

(76) Inventor: David A. Hill, Bend, OR (US)

Correspondence Address: KOLISCH HARTWELL, P.C., 520 S.W. YAMHILL STREET, SUITE 200, PORTLAND, OR, 97204, US

(21) Appl. No.: 10/638,104

(22) Filed: Aug. 7, 2003

(51) Int. Cl. B05D 5/00

(52) U.S. Cl. 156/548; 427/256; 427/207.1; 156/578

(57) ABSTRACT

Systems and methods for depositing glue on workpieces transported on a conveyor utilizing apparatus for mixing rapid gelling glue components and depositing glue mixtures in defined patterns.

### FIELD OF THE INVENTION

The invention relates to bonding of materials. In particular, an example of the invention involves application of rapid curing adhesive to bond wood components together.

### BACKGROUND AND SUMMARY OF THE INVENTION

In woodworking applications, it is often necessary to bond wood pieces together to produce a wood product. For example, recent environmental regulations and depletion of old-growth timber supplies have made it increasingly difficult and expensive for manufacturers to obtain high-grade lumber to use in wood products, for example including furniture, cabinets and millwork. One way of addressing the shortage and high cost of high quality lumber is the use of veneered stock. Typically, veneered wood products are created by laminating high quality veneer over a lower grade core material, such as medium density fiberboard (MDF), particle board, plywood or finger-jointed stock. Use of veneered wood members results in a substantially more efficient utilization of high quality wood, and therefore reduces raw material costs. Other examples of wood products produced by joining wood members together include door and window jambs, plywood, laminated veneer lumber, and other laminated wood products.

For most woodworking applications, a wood bond must be strong in order to provide structural strength and stability. For example, it is often desirable to form a “high-strength wood bond” that has a shear-strength exceeding the shear-strength of the wood itself. Generally, high strength wood bonding procedures require application of an adhesive to a wood surface, and subsequent pressing of the wood surface against another wood surface or against a polymeric material such as PVC, polyethylene, polystyrene, polypropylene, phenolic paper and wood fiber composites with any one of the above-listed polymers.

One significant limitation with prior wood bonding techniques is that the procedure required to produce a high-strength wood bond may take a long time, for example, several hours, to produce a cured product.

Other procedures can be performed more rapidly by using an adhesive that is activated to some extent during the pressing process. For example, adhesives may be activated by applying heat. These adhesives are referred to as “thermoset adhesives.” Presses may use heating platens or radio frequency mechanisms to activate and speed up significantly the cure time of a thermoset adhesive. Presses with heat activation mechanisms are generally complex, and expensive. These presses may also be limited in their ability to achieve uniform curing in some composite configurations.

Another way of activating an adhesive during pressing is to use a two-part adhesive system in which the two parts are substantially separate and unmixed until the pressing step, sometimes referred to as a “honeymooning” process. For example, see U.S. Pat. Nos. 5,944,938 and 5,626,705. However, a problem with this approach is that the pressing step may not adequately or reproducibly mix the two adhesive parts, thereby creating an inferior or inconsistent bond, or causing delays in the curing process. Another problem with a honeymooning process is that it is difficult to control the actual ratio of mixed adhesive components due to variable penetration or dilution of the components into the wood prior to mixing, particularly where the moisture content of the wood is variable.

There is a need for simplified wood bonding systems and procedures that can produce a rapidly-curing, high-strength wood bond between different types of wood pieces having a wide range of possible moisture contents, and between wood and polymeric materials such as vinyl, without requiring complicated adhesive activation steps while the wood pieces are being pressed.

The current inventor previously filed U.S. patent application Ser. No. 10/007,624 which discloses uses of rapid gelling two-part adhesive systems to quickly form high strength bonds between materials. This application is hereby incorporated by reference in it entirety, and is not in any way admitted to be prior art relative to the current invention.

One of the challenges with using rapid curing adhesives is that the fluid adhesive must be channeled, accurately metered, and uniformally dispensed over a short time window during which the fluidic properties of the adhesive change significantly as polymeric bonds are formed and the curing process moves rapidly toward completion. Various applicating systems are disclosed in the '624 application. Some of the previously disclosed systems involve spray techniques. However, some desirable adhesive formulations may not be conducive to spraying application.

Accordingly, an example of the invention involves use of a dispensing tube suspended across a material conveyor. The tube has a plurality of apertures for dispensing adhesive. Rapid gelling adhesive components are mixed and injected into both ends of the tube, and subsequently dispensed through the apertures onto material such as wood veneer being conveyed below the tube. The tube oscillates in a direction non-parallel to the direction of material travel so that the adhesive is deposited in a nonlinear pattern configured to result optimally in a uniform film of desired thickness when the adhesive is sandwiched and pressed between material components.

In another example of the invention multiple dispenser heads are arranged across a conveyor path. Each conveyor head has a conduit defining a stream path for directing glue fluid toward a work piece being transported along the conveyor path, and a drive mechanism for causing the stream path to oscillate resulting in a repeating pattern of glue on the work piece.

In another example of the invention, a plurality of glue mixing and applicating mechanisms are suspended across a conveyor. Each applicating mechanism is equipped with a drive mechanism configured to reciprocate a dispenser so that glue is deposited in a repeating zigzag pattern on materials being conveyed along a processing path.

### BRIEF DESCRIPTION OF THE DRAWINGS

FIG. 1 is a perspective view of a system and apparatus for dispensing glue onto a workpiece.

FIG. 2 is a partial perspective view of the system and apparatus shown in FIG. 1, focusing in on a glue mixing and injecting device.

FIG. 3 is a schematic view illustrating the concept of dispensing glue in multiple zigzag patterns from an oscillating tube.

FIG. 4 is a series of schematic drawings illustrating a device for aligning and routing workpieces edge-to-edge prior to a glue dispensing station.

FIGS. 5-9 are schematic views of glue application patterns that may be achieved with different examples of the invention.

FIG. 10 is a schematic top view of a glue application device oriented obliquely relative to a material transport path.

FIG. 11 is a partial perspective view of another example of the invention in which a plurality of applicators are individually oscillated.

FIG. 12 is another partial perspective view of another example of the invention in which applicators are individually driven to produce adjacent zigzag patterns of glue.

FIG. 13 shows a partially exploded isometric view of an applicator used in the example shown in FIG. 12.

FIG. 14 is a schematic sectional view through the device shown in FIG. 13.

FIG. 15 is a partial side view of another glue dispensing mechanism.

FIG. 16 is a partial cross sectional view of the glue dispensing mechanism of FIG. 15.

FIG. 17 shows an applied glue pattern achieved with the dispensing mechanism shown in FIGS. 15 and 16.

### DESCRIPTION OF EXAMPLES OF THE INVENTION

The invention includes numerous systems, devices, and methods for depositing glue on material. One aspect of the invention involves a method of mixing rapidly gelling glue systems and depositing the glue uniformly on a moving work piece. For example, the glue may be deposited in a pattern including multiple side-by-side zigzag lines.

Another aspect of the invention utilizes equipment including a tube suspended over a conveyor path. The tube has apertures for dispensing glue which flows into the tube from opposite ends. A drive mechanism causes the tube to oscillate back and forth along a direction non-parallel to the conveyor path, thereby producing multiple repeating adjacent zigzag patterns of glue on the work piece. The glue patterns may be completely separate or may overlap.

Still another aspect of the invention utilizes multiple dispenser heads, each having its own glue injector, mixing chamber, and drive mechanism for repeatably altering the dispense path of a glue mixture. Numerous variables can be tuned and controlled to achieve an infinite number of different glue application objectives. For example, the invention may be used to permit relatively fast glue flow rates compared to a relatively slow material transport rate which is sometimes necessary with glue systems formulated to gel and cure quickly.

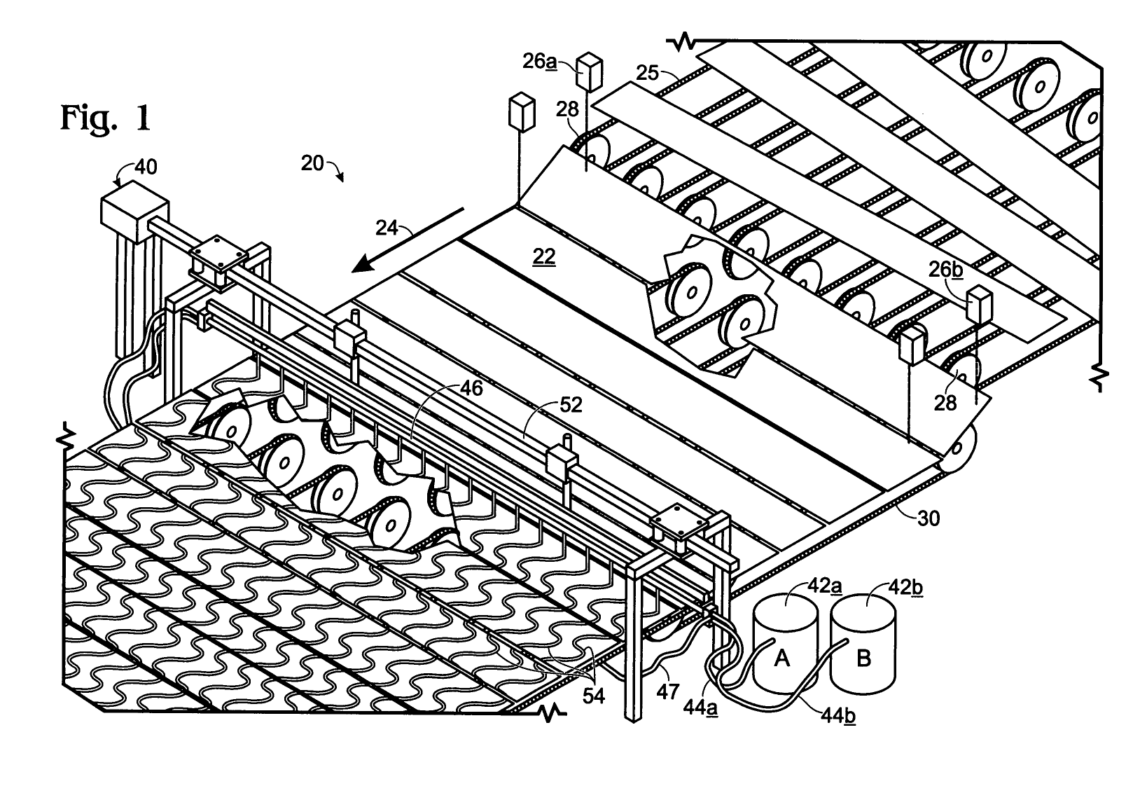

FIG. 1 shows an example of the invention. Glue or adhesive applicator system 20 is shown conveying work pieces 22 along processing path 24. Individual workpieces 22 are conveyed by infeed 25. Workpieces 22 being conveyed upstream may be spaced apart and skewed. Eyes or sensors 26a and 26b detect the presence of workpiece ends, causing appropriate independent stopping and/or starting of conveyor belts 28 so that workpiece 22 is oriented perpendicular to processing path 24 prior to being transferred to crowder outfeed 30. Infeed 25 generally runs faster than outfeed 30 so that workpieces are arranged edge-to-edge on crowder outfeed 30. For example, infeed 25 may run at approximately 200-ft-per-minute while outfeed 30 runs at approximately 30- to 60-ft-per-minute.

Crowder outfeed 30 then becomes the conveyor infeed for glue applicator station 40. Workpieces 22 then translate through glue application station 40. Glue applicator station 40 is configured to dispense a mixture of a two-part rapid-curing adhesive system. Component A of the adhesive system is contained in reservoir 42a. Component B of the adhesive system is contained in reservoir 42b. For example, a glue system may be obtained for this purpose from Bordon. A resin blend of WS 749-002 and WS 749-010 has been used with catalyst number WS 730-139. The gel time for this system is approximately 5 minutes. Hoses 44a and 44b carry the adhesive components through pumps and temperature control equipment before entering a mixing chamber, and flowing through dispense tube 46. Purge hose 47 is provided to clean out and purge tube 46 when it is not being used to dispense glue. Water, air, or other appropriate fluids may be used for purging.

Tube 46 has multiple holes for dispensing glue onto workpieces 22. Tube 46 may, for example, have an outer diameter of 5/16-inch. The tube may be suspended by about three- to five-inches, or up to 20-inches or more for other applications. Both sides of tube 46 are equipped with an adhesive mixing and pumping system, as previously described, so that a gelling adhesive mixture is injected into the tube from both ends toward the center of tube 46. The holes or apertures in tube 46 may have uniform or varying diameters that increase somewhat towards the center of tube 46 to compensate for a drop in pressure as the glue flows through tube 46. For example, the diameters of the holes are in the approximate range of 30-40 thousandths-of-an-inch.

Tube 46 is connected to rail 52. A mechanism is provided to oscillate or reciprocate rail 52 and tube 46 resulting in deposition of zigzagging glue pattern 54. Any mechanism for oscillating tube 46 may be used. For example, a rotary reciprocator may be used. Alternatively, a hydraulic cylinder, pneumatic cylinder, hydraulic rotary actuator, or pneumatic rotary actuator may be used.

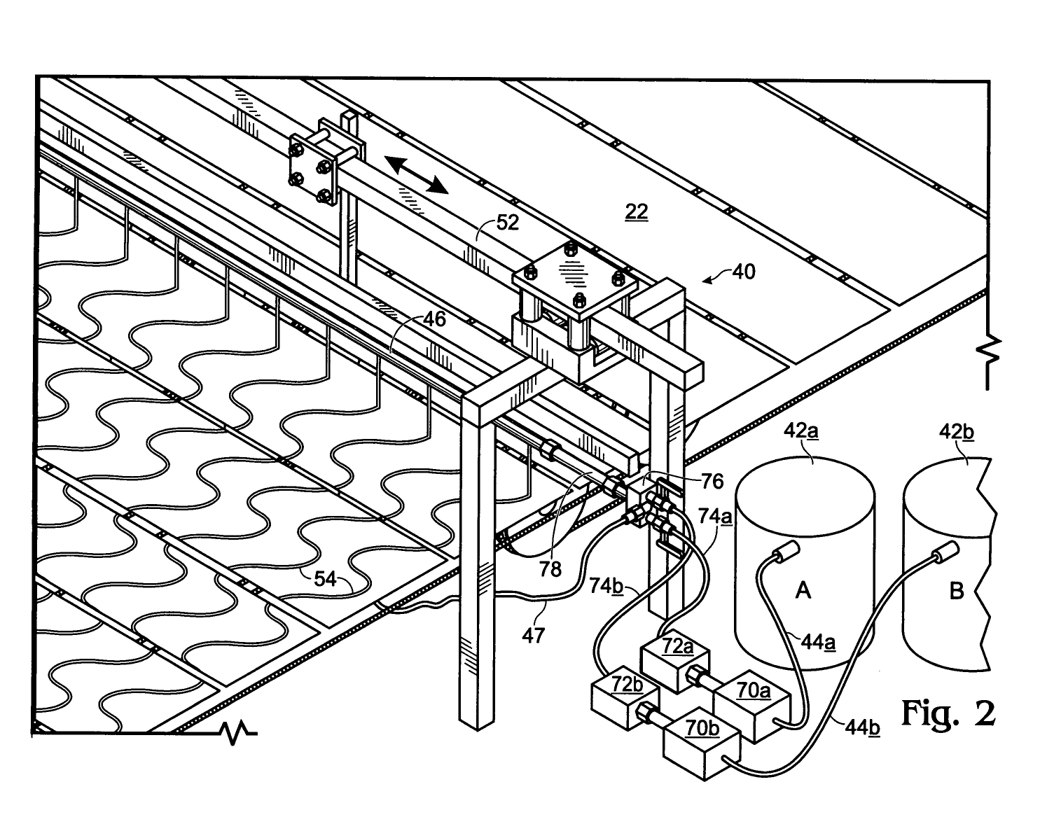

FIG. 2 shows a close up view of glue applicator station 40. Glue components 42a and b are contained in reservoirs 42a and 42b, respectively. Hoses 44a and 44b carry glue components A and B through pumps 70a and 70b, and temperature control devices 72a and 72b prior to mixing. For example, a two-part resorcinol adhesive system with relatively high solids and low water content is used. The product is obtained from Borden. Glue components A and B are then carried through temperature-controlled hoses 74a and 74b, respectively, into junction 76 where the glue components are combined and then mixed in static mix tubes 78. For example, temperature-controlled hoses 74a and 74b may be configured to maintain the temperature of the glue at around 150° F. The mixed glue then travels through tube 46 where it is dispensed through apertures, as previously described.

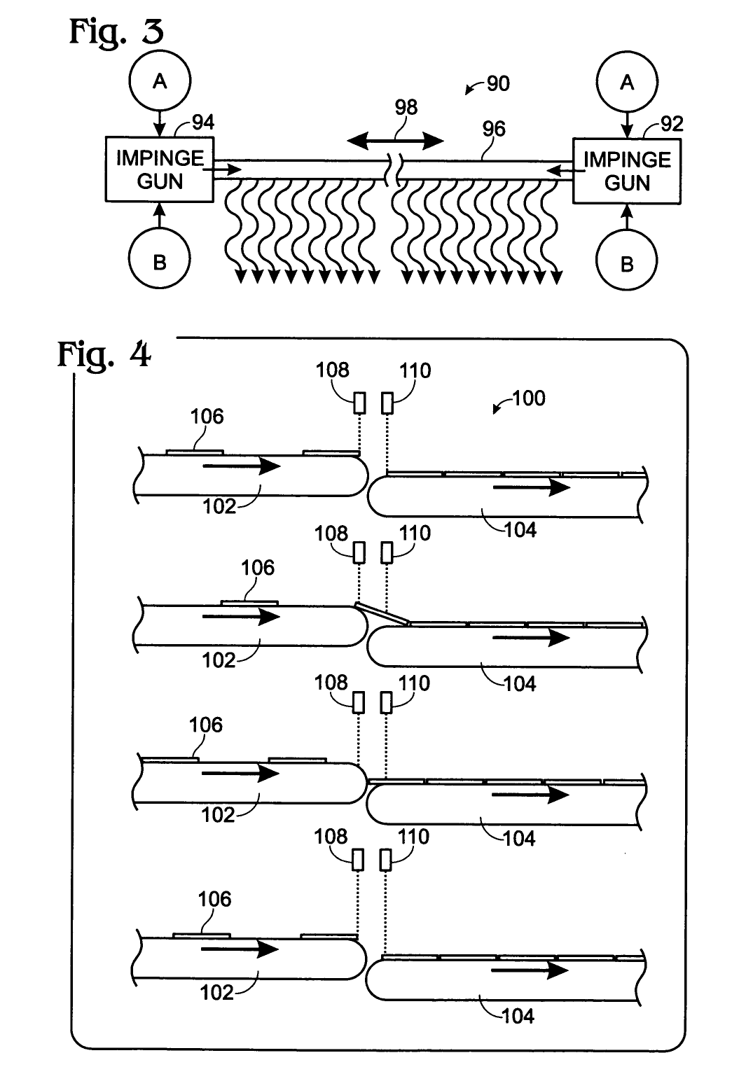

FIG. 3 shows a schematic illustration of glue applicator station 90. Separate impinge guns or glue injector devices 92 and 94 are positioned at opposite ends of tube 96. Additional glue sources may be positioned at intermediate locations along tube 96. Impinge guns 92 and 94 inject glue mixtures towards the center of tube 96. An oscillation device is used to move tube 96 back and forth in the direction of arrows 98.

FIG. 4 is a series of schematic side views of a crowding conveyor device 100 for both deskewing or aligning workpieces, and arranging them edge-to-edge upstream from a glue applicator station, for example, as shown in FIG. 1. Infeed conveyor 102 is elevated relative to outfeed conveyor 104. Workpieces 106 on infeed conveyor 102 may be skewed and/or spaced apart. Haphazard workpiece spacing on a conveyor is not conducive to uniform and efficient glue application, particularly where it is desirable for the glue dispensing system to run continuously for long periods. Plural sensors 108 (only one shown) are arranged across the conveyor path near the end of infeed conveyor 102. Sensors 108 detect the edge of workpiece 106. If workpiece 106 is skewed, then the chain or track supporting the leading edge of workpiece 106 stops until the remaining edge catches up and is sensed by another sensor. Another sensor or set of sensors 110 is positioned near the upstream end of outfeed 104. When sensor 110 detects the trailing edge of workpiece 106, then a signal is sent to a controller which turns on infeed 102 to deliver another workpiece 106 to outfeed conveyor 104, as shown in the second view in FIG. 4.

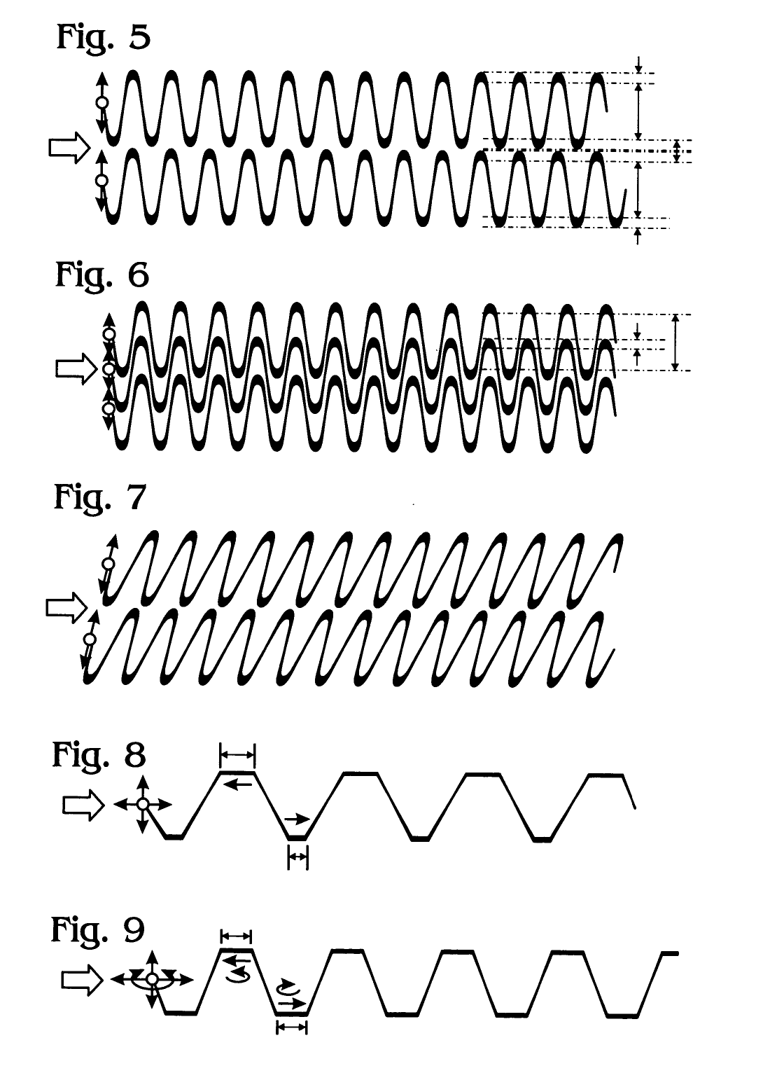

FIGS. 5-7 show different glue application patterns that may be achieved by varying the configuration of the glue applicator system, as previously described. FIG. 5 shows parallel zigzag patterns resulting from oscillation of an applicator tube with plural apertures, the tube being oriented substantially perpendicular to the conveyor path direction.

FIG. 6 shows a variation of the glue pattern of FIG. 5 in which the individual zigzag paths overlap to some extent. A pattern in FIG. 6 may be useful if there is a disparity between the amount deposited at the apex (direction reversal) versus the linear portions of each path. FIG. 7 shows the result of altering the line of deposition to be obliquely oriented relative to the conveyor path.

FIGS. 8 and 9 show further glue pattern variations that are achieved by adding one or more additional movements to a deposition tube or nozzle, in addition to side-to-side oscillating movement as previously described. In FIG. 8, the deposition node is oscillated in two directions that are perpendicular to each other. FIG. 9 shows a glue deposition design produced by moving a deposition aperture or node in the same direction shown in FIG. 8, and additionally rotating the deposition tube around its axis to some extent.

Numerous other deposition patterns may be achieved by, for example, using a tip device to alter the dispersion path of the glue. For example, a tip configuration may be used to generate a spray-like dispersion which may or may not be used in conjunction with an oscillating motion.

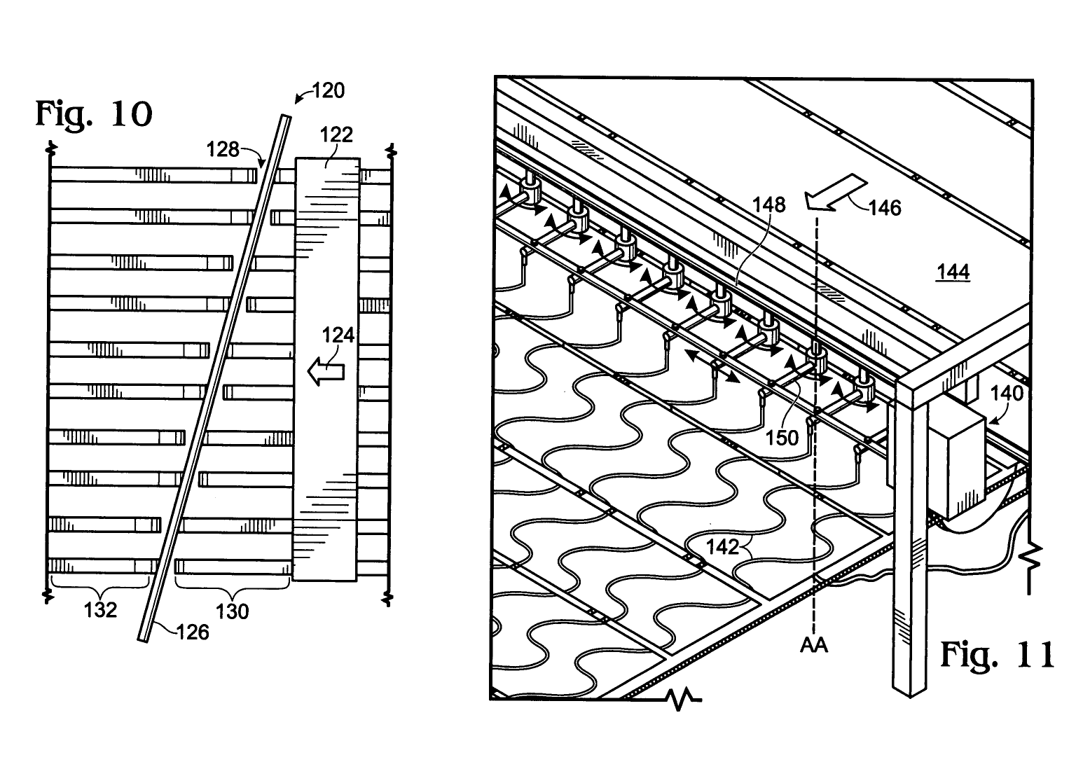

FIG. 10 shows a glue deposition configuration that may be used to create a glue pattern such as the one shown in FIG. 7. Glue applicator station 120 is shown in FIG. 10. Workpiece 122 is conveyed along conveyor path 124. Glue deposition tube 126 is oriented obliquely relative to conveyor path 124. Gap 128 is defined between conveyor sets 130 and 132 to facilitate purging and servicing of applicator tube 126. Conveyor tracks in each set 130 and 132 are staggered so that gap 128 is aligned with tube 126. An advantage of this configuration is that workpiece 122 passes over gap 128 gradually, with continuous support from the conveyors, in contrast to a different configuration in which a conveyor gap is perpendicular to the conveyor path.

FIG. 11 shows an alternative example of the invention. Glue application system 140 is used to deposit glue lines 142 on workpieces 144 along conveyor path 146. Tube 148 receives mixed adhesive from both ends, as previously described. A plurality of deposition devices 150 branch off of tube 148. Each deposition device 150 has a drive mechanism such as a motor for rotating the device back and forth to some extent around axis AA.

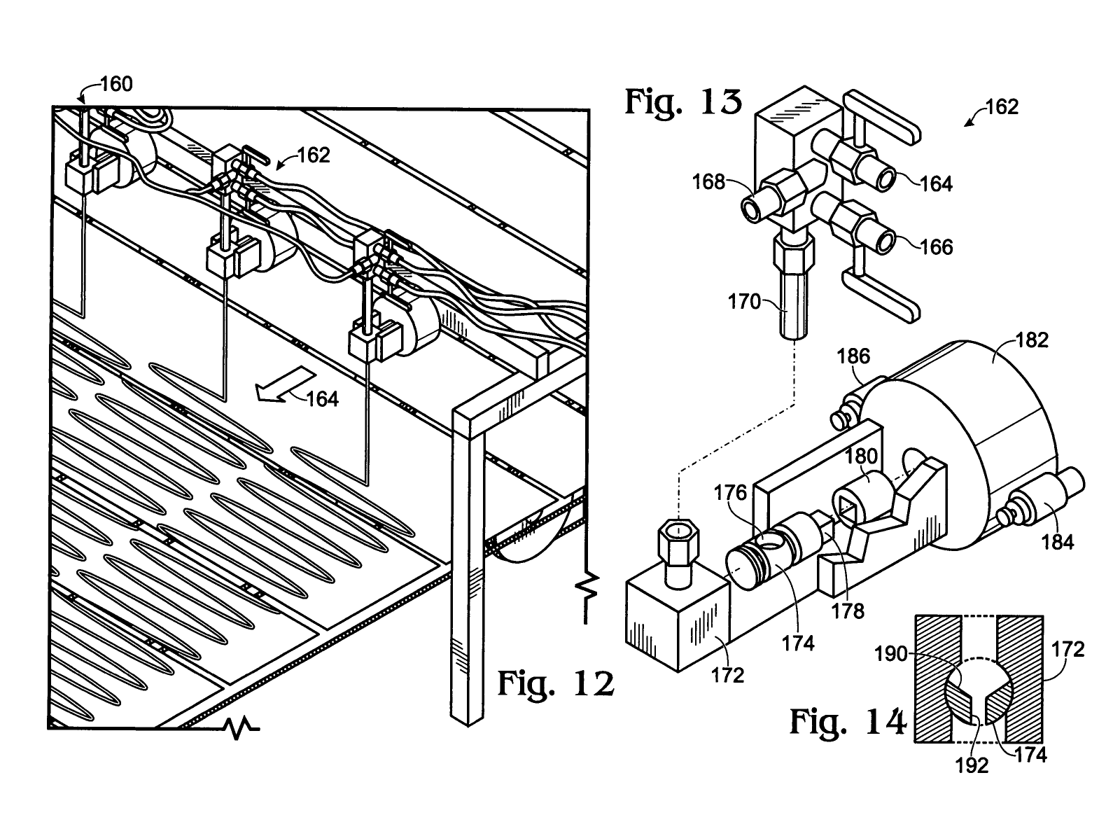

FIGS. 12-14 show another example of the invention. Similar to the examples shown in FIG. 11, a plurality of deposition devices are driven individually and independently to produce the desired deposition pattern. Additionally, in the example shown in FIGS. 12-14, each deposition device receives individual glue components, and mixes the glue system immediately before depositing the mixture on the workpiece. This configuration enables use of glue components that gel quite rapidly, for example, in less than 15, 10, or 5 minutes. As shown in FIG. 12, glue applicator station 160 has multiple glue applicating devices 162 arranged across conveyor path 164. Each glue application device 162 has two glue lines for carrying glue components A and B separately, and a purge line for carrying water or some other fluid to keep the deposition conduit clear when not being used.

FIG. 13 shows glue application device 162 partially exploded. Fittings 164 and 166 are provided for receiving glue components A and B. Fitting 168 is provided for receiving water to purge the line. Glue component lines join and merge into static mix tube 170. Static mix tube 170 feeds into housing block 172. Housing block 172 may be positioned, for example, approximately two feet above the conveyor. Rotating cylinder 174 is seated in housing block 172. Cylinder 174 has a funnel-shaped aperture 176 for receiving mixed glue. Nut portion 178 is received in female fitting 180 which is rotationally driven by drive mechanism 182. Air lines 184 and 186 are provided for pneumatic operation of drive mechanism 182.

FIG. 14 shows a cross-section through housing block 172 and rotating cylinder 174. Rotating cylinder 174 has a funnel-shaped portion 190 leading to a straight conduit portion 192.

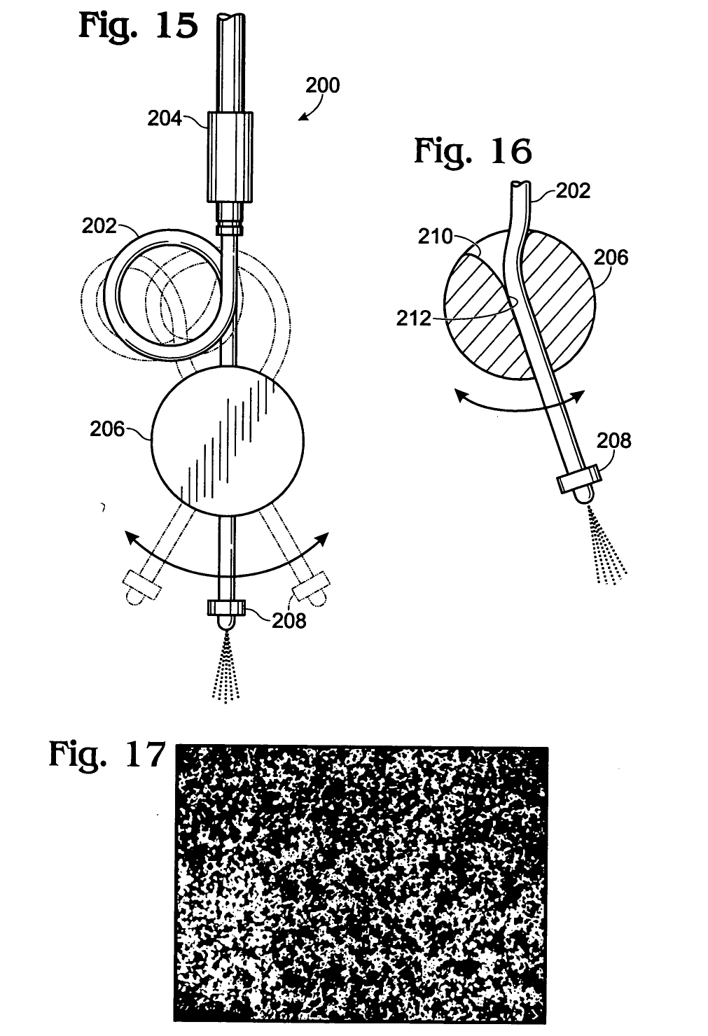

FIG. 15 shows another glue dispensing mechanism 200 using a flexible tube 202 and a device for oscillating the tube back and forth to produce a glue pattern on a work piece in accordance with examples described above. Flexible tube 202 is fed an activated glue mixture from pumping and mixing apparatus as previously described. Tube 202 may, for example, be made of Teflon and have an outer diameter of ⅛-inch and an inner diameter of 1/16-inch. Tube 202 makes a 360-degree loop after exiting static mix tube 204. Tube 202 then passes through a graduated aperture in rotating cylinder 206. Tube 202 also may have tip 208 for creating a particular stream or spray distribution.

FIG. 16 shows a cross section through rotating cylinder 206. As shown, upper portion 210 of passage or aperture 212 is graduated. Rotating cylinder 206 may be positioned approximately 5- or 6-feet above the material being conveyed. The cylinder rotates rapidly, for example, approximately 700-oscillations-per-minute. A single dispenser has been used to deposit glue uniformly across an 8-foot material width.

FIG. 17 shows a glue splatter pattern created by an application device such as the one shown in FIGS. 15 and 16.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

1. A method of dispensing adhesive comprising
conveying a piece of material along a processing path under an adhesive dispenser, and
dispensing adhesive through an oscillating aperture on to the material.

2. The method of claim 1, wherein the oscillating aperture generates a splatter pattern on the material.

3. The method of claim 1, wherein the oscillating aperture generates an adhesive pattern including a continuous nonlinear bead.

4. The method of claim 1, wherein the dispensing step includes separately mixing rapid gelling adhesive components at plural stations arranged across the processing path while oscillating an adhesive projection path at each station.

5. The method of claim 3, wherein the bead is zigzagged.

6. The method of claim 1, wherein the dispensing step includes applying multiple zigzagged beads.

7. The method of claim 6, wherein each bead has a series of apexes at least partially offset from the apexes of adjacent beads.

8. The method of claim 1, further comprising
varying the flow rate of adhesive on to the material.

9. The method of claim 1, further comprising
mixing adhesive components prior to dispensing, the adhesive components being formulated to cure without heating or radio frequency treatment in less than about twenty minutes.

10. The method of claim 1, further comprising
mixing adhesive components prior to dispensing, the adhesive components being formulated to cure without heating or radio frequency treatment in less than about ten minutes.

11. The method of claim 1, further comprising
mixing adhesive components prior to dispensing, the adhesive components being formulated to cure without heating or radio frequency treatment in less than about ten minutes.

12. The method of claim 1, further comprising
oscillating the adhesive dispenser in a direction non-parallel to the direction of material conveyance.

13. The method of claim 1, wherein the dispenser comprises a tube having multiple apertures.

14. The method of claim 13, wherein the material is conveyed along a processing path, the tube being oriented non-parallel to the processing path.

15. The method of claim 13, wherein the material is conveyed along a processing path, the tube being oriented substantially perpendicular to the processing path.

16. The method of claim 13, wherein the material is conveyed along a processing path, the tube being oriented obliquely relative to the processing path.

17. The method of claim 13, wherein the apertures have diameters of varying diameters, the diameters being larger closer to the center of the tube.

18. The method of claim 13, wherein the tube has two ends and adhesive injector devices at each end.

19. A system for bonding materials together comprising
a conveyor for conveying a piece of material along a processing path, and
an adhesive dispenser having at least one oscillating aperture positioned over the processing path configured to dispense a nonlinear adhesive pattern on to the material.

20. The system of claim 19, wherein the pattern includes at least one nonlinear bead.

21. The system of claim 19, wherein the dispenser has multiple apertures for dispensing multiple zigzagged beads.

22. The system of claim 21, wherein each bead has a series of apexes at least partially offset from the apexes of adjacent beads.

23. The system of claim 19, further comprising
a variable flow adhesive metering device so that the flow rate through the aperture can be varied.

24. The system of claim 19, further comprising
an oscillator device connected to the dispenser for moving the dispenser in a reciprocating motion non-parallel to the direction of material conveyance.

25. The system of claim 24, wherein the oscillator device includes at least one of the following: a rotary reciprocator, a hydraulic cylinder, a pneumatic cylinder, a hydraulic rotary actuator, a pneumatic rotary actuator.

26. The system of claim 20, wherein the dispenser includes a tube having multiple apertures positioned above the processing path.

27. The system of claim 26, wherein the tube is oriented non-parallel to the processing path.

28. The system of claim 26, wherein the tube is oriented substantially perpendicular to the processing path.

29. The system of claim 26, wherein the tube is oriented obliquely relative to the processing path.

30. The system of claim 26, wherein the tube has multiple apertures, at least some of the apertures having larger diameters, relative to other apertures, in a center region of the tube.

31. The system of claim 26, further comprising
multiple adhesive injector devices connected to the tube at different locations along the tube.

32. The system of claim 31, wherein the tube has two ends, and an adhesive injector device connected to each end of the tube.

33. The system of claim 26, further comprising
at least one elbow-shaped conduit connected to the tube and an oscillating device configured to move the conduit relative to the tube to produce a non-linear bead on the material.

34. The system of claim 19 further comprising
a crowding device positioned up stream from the adhesive dispenser configured to align and position pieces of material edge-to-edge so the adhesive dispenser can run continuously.

35. The system of claim 19 further comprising
at least two adhesive reservoirs connected to the tube via hoses and a mixing chamber.

36. The system of claim 35, wherein each reservoir contains one of two adhesive components formulated to cure in less than about twenty minutes after mixing.

37. The system of claim 35, wherein each reservoir contains one of two adhesive components formulated to cure in less than about ten minutes after mixing.

38. The system of claim 37, wherein the adhesive components comprise a two-part resorcinol system.
